(19) United States
(12) Patent Application Publication
(10) Pub. No.: US 2004/0020332 A1
(43) Pub. Date: Feb. 5, 2004

(54) Wrench opening

(76) Inventor: Chih Ching Hsieh, Chong Ho City (TW)

Correspondence Address: Chih Ching HSIEH, P.O. Box 10-69, Chong Ho, Taipei, 235, TW

(21) Appl. No.: 10/211,645

(22) Filed: Aug. 5, 2002

(51) Int. Cl. B25B 13/00

(52) U.S. Cl. 81/186

(57) ABSTRACT

A wrench cooperating with a fastener which includes a number of surfaces joining each other at respective corners of the fastener, the wrench includes a head having an enclosed opening, or open opening, each of which has two or more surfaces or sides, and two curved bulges extended or provided on each of the surfaces or sides, and a curved recess formed between the bulges. The head may further include a projection extended in each of the recess and extended between the bulges for engaging with the surface portions that are spaced from the corners of the fastener.

### BACKGROUND OF THE INVENTION

1. Field of the Invention

The present invention relates to a wrench, and more particularly to a wrench having a wrench opening for engaging with the flat surfaces of the fasteners.

2. Description of the Prior Art

Various kinds of typical wrenches have been developed for driving hexagonal fasteners which have a plurality of substantially flat and planar surfaces that join each other at respective edges or corners of the fasteners.

For example, U.S. Pat. No. 3,903,764 to Andersen, U.S. Pat. No. 4,765,211 to Colvin, U.S. Pat. No. 5,092,203 to Mader et al., U.S. Pat. No. 5,219,392 to Ruzicka et al., U.S. Pat. No. 5,388,486 to Ruzicka et al, and U.S. Pat. No. 5,476,024 to Hsieh, disclose several of the typical wrenches and comprise a substantially hexagonal wrench opening formed therein, and having rounded spaces formed in the corners for receiving the corners of the fasteners, and for allowing the fasteners to be slightly rotated relative to the wrench.

The typical wrenches comprise a number of edges or teeth or bulges for engaging with the corners of the fasteners, and for driving or rotating the fasteners. However, when the edges or the corners of the fasteners are rounded or have been worn out, the fasteners may no longer be rotated or driven by the typical wrenches.

Some of the typical wrenches comprise a number of rounded or curved bulges extended into the wrench opening for engaging with the planar surfaces of the fasteners. However, when the wrench is rotated relative to the fastener, the edges or the corners of the fasteners will also be rotated to engage with the wrench so as to be driven by the wrench, such that the wrench also may not be used for rotating or driven the fasteners having rounded corners or worn out corners.

The present invention has arisen to mitigate and/or obviate the afore-described disadvantages of the conventional wrenches.

### SUMMARY OF THE INVENTION

The primary objective of the present invention is to provide a wrench including a wrench opening for engaging with the flat surfaces of the fasteners instead of engaging with the corners of the fasteners, and for allowing the wrench to drive the fasteners when the corners of the fasteners are rounded or have been worn out.

In accordance with one aspect of the invention, there is provided a wrench cooperating with a fastener, wherein the fastener includes a plurality of surfaces joining each other at respective corners of the fastener, the wrench comprising a driving cylindrical member including an enclosed opening formed therein and having six corner spaces and six sides provided therein, the six sides of the driving cylindrical member each including two bulges formed and provided therein for engaging with the surfaces of the fastener, and a recess formed between the bulges respectively.

The driving cylindrical member further include three projections extended in the recesses thereof respectively and extended and disposed between the bulges.

The driving cylindrical member may be a driving head or a driving socket.

The wrench includes a handle having a first end and a second end, and having the driving cylindrical member disposed on the first end of the handle, and having a head provided on the second end of the handle, the head includes an open opening formed and defined between two parallel wrench flats, and two bulges extended from each of the wrench flats respectively, and a recess formed between the bulges respectively, for allowing the bulges to engage with a middle portion of the surface of the fastener that is spaced from the corners of the fastener.

The head include two projections extended in the recesses thereof respectively and extended and disposed between the bulges of each of wrench flats of the head.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of a wrench in accordance with the present invention;

FIG. 2 is a top plan view of the wrench;

FIGS. 3, 4, 5, 6 are partial top plan views illustrating the operation of the wrench;

FIG. 7 is a partial exploded view illustrating a socket having a wrench opening of the present invention;

FIG. 8 is a perspective view illustrating the operation of the socket as shown in FIG. 7 to be driven by a wrench tool;

FIG. 9 is a perspective view illustrating another embodiment of the wrench;

FIG. 10 is a top plan view of the wrench as shown in FIG. 9;

FIGS. 11, 12, 13, 14 are partial top plan views illustrating the operation of the wrench as shown in FIGS. 9 and 10;

FIG. 15 is a partial exploded view illustrating a socket having a wrench opening similar to that shown in FIGS. 9-11 and 13; and

FIG. 16 is a perspective view illustrating the operation of the socket as shown in FIG. 15 to be driven by a wrench tool.

### DETAILED DESCRIPTION OF THE PREFERRED EMBODIMENT

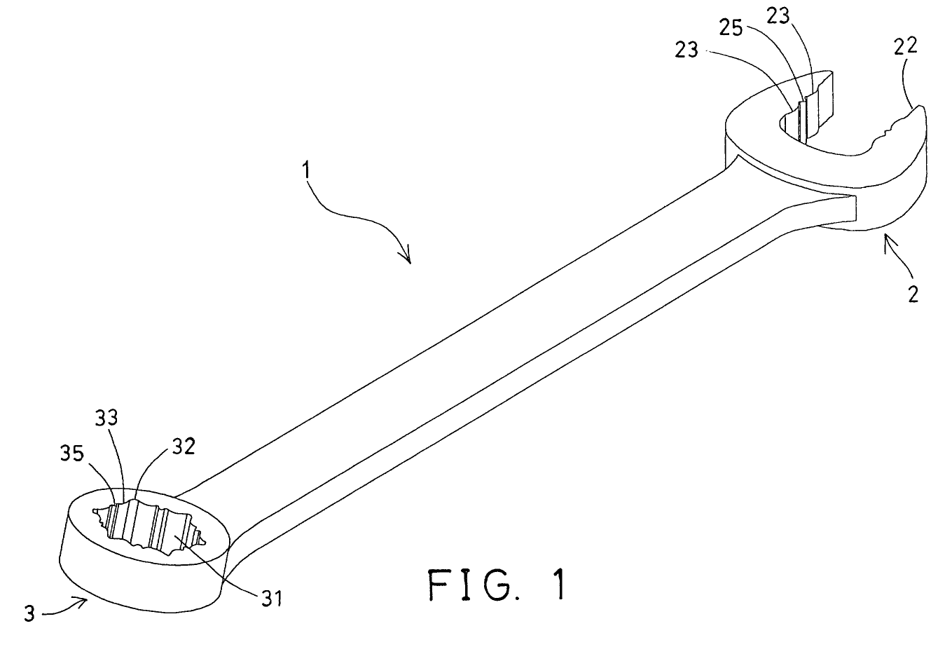

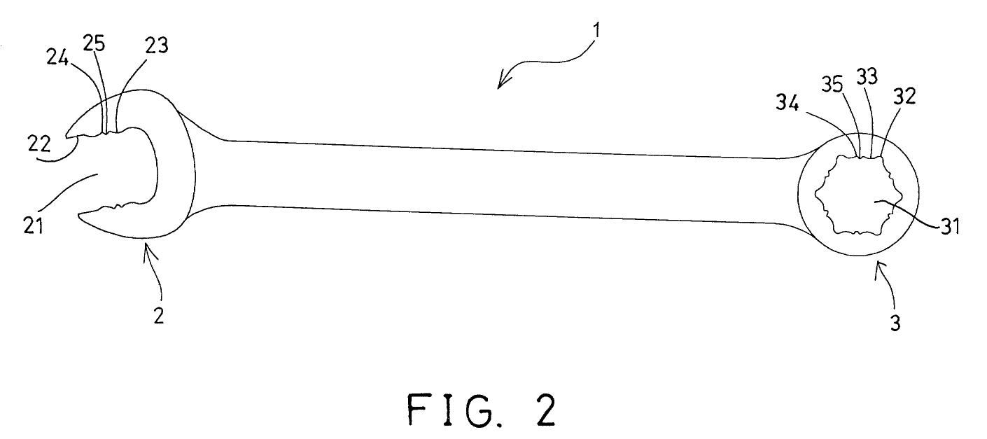

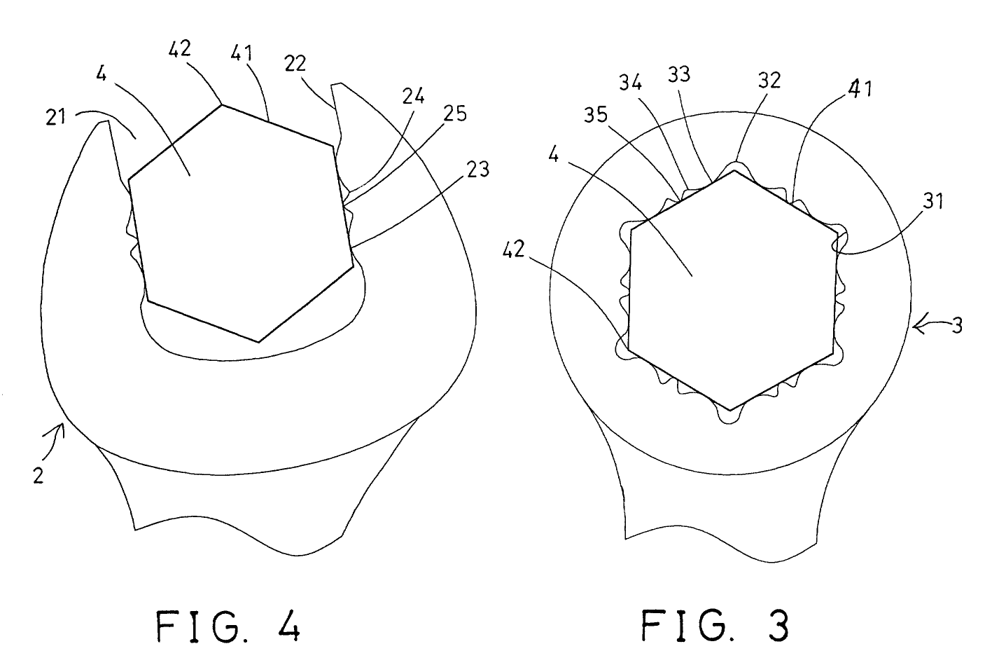

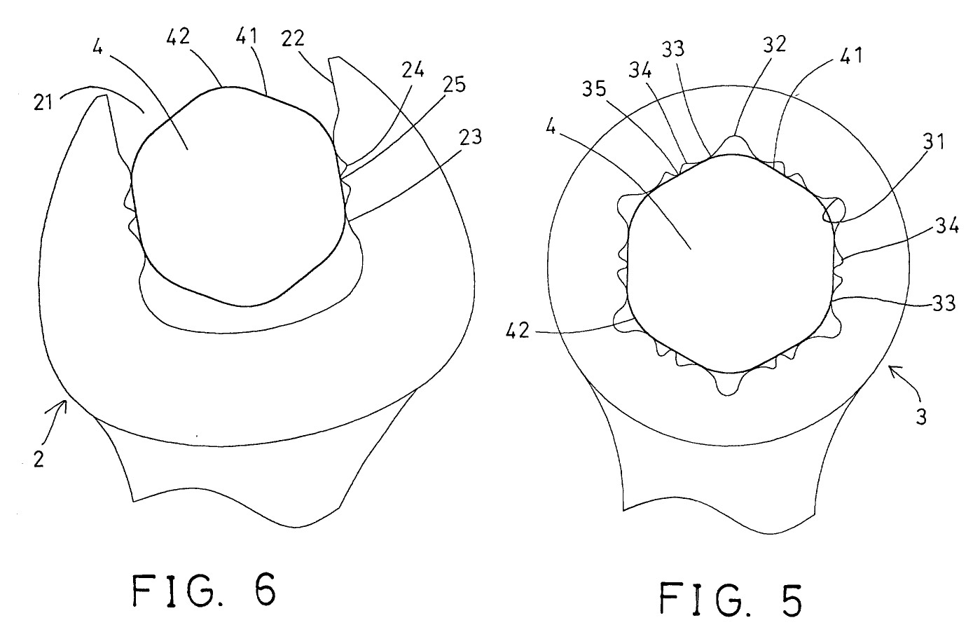

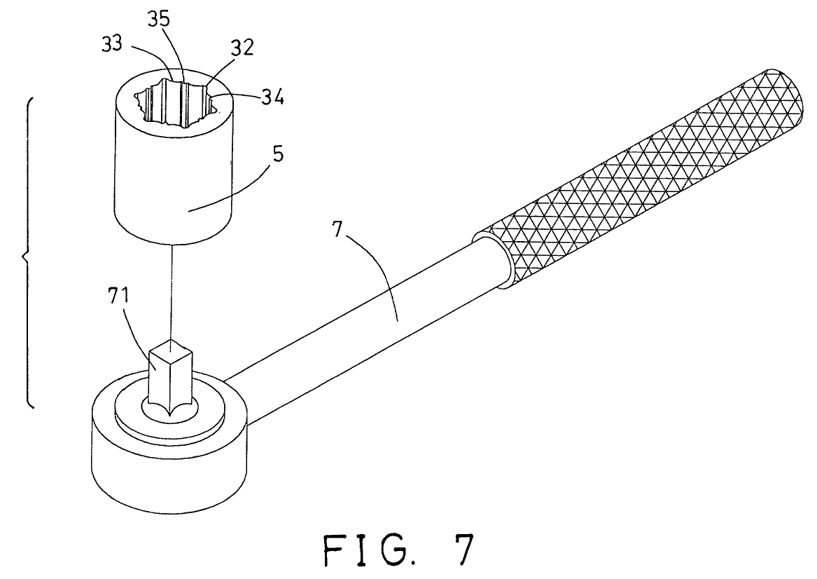

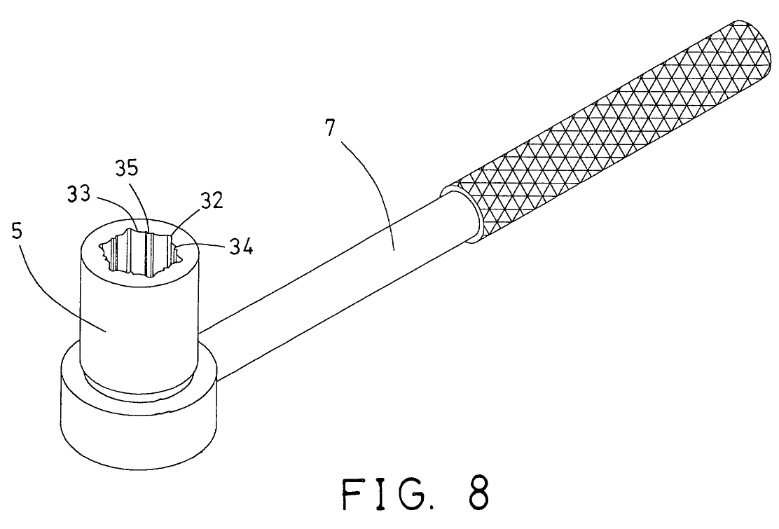

Referring to the drawings, and initially to FIGS. 1 and 2, a wrench in accordance with the present invention comprises a handle 1 including one or two driving heads 2, 3 provided on one or both the ends thereof, for receiving and for driving hexagonal fasteners 4 (FIGS. 3-6).

For example, the fasteners 4 each has a plurality of or three pairs of substantially flat and planar surfaces 41 that join each other at respective edges or corners 42 of the fasteners 4. For example, the head 2 includes an open opening 21 formed therein, and the other head 3 includes an enclosed opening 31 formed therein for receiving the fasteners 4.

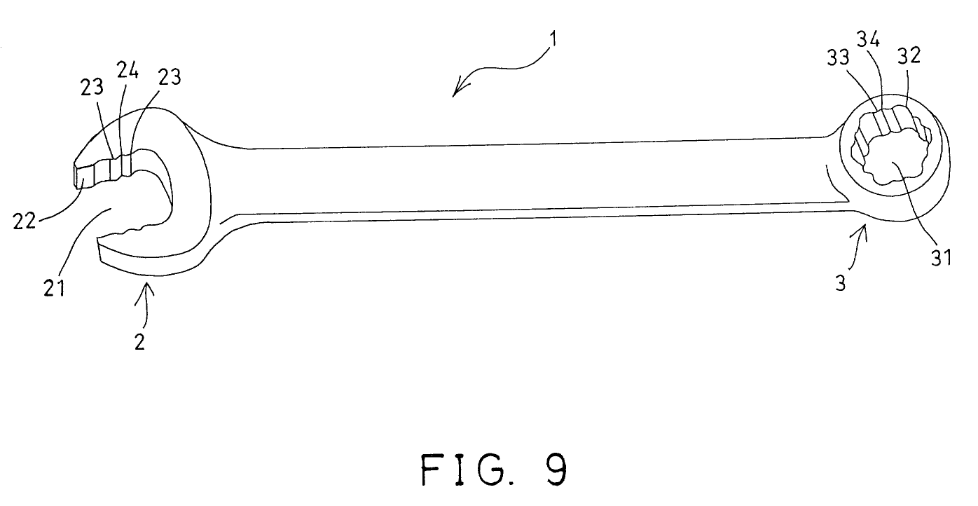

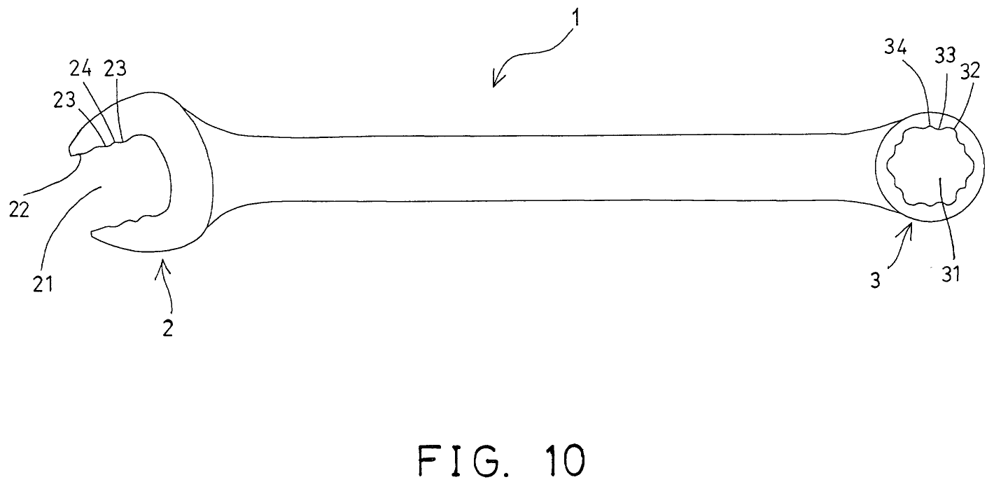

The driving head 2 includes two wrench flats 22 which are parallel to each other and spaced apart a sufficient distance to loosely accommodate the confronting flat surfaces 41 of the hexagonal fastener 4, and two rounded bulges 23 extended from each of the wrench flats 22 respectively, such as extended from the middle portions of the wrench flats 22 respectively, and a curved recess 24 formed between the bulges 23 of the respective wrench flats 22 (FIGS. 9, 10, 12, 14).

As shown in FIGS. 1, 2, 4, and 6, the driving head 2 further includes a projection 25 extended in the curved recess 24 thereof and located between the rounded bulges 23, and preferably steeper than that of the rounded bulges 23, for engaging with the middle portions of the respective edges or corners 42 of the fasteners 4.

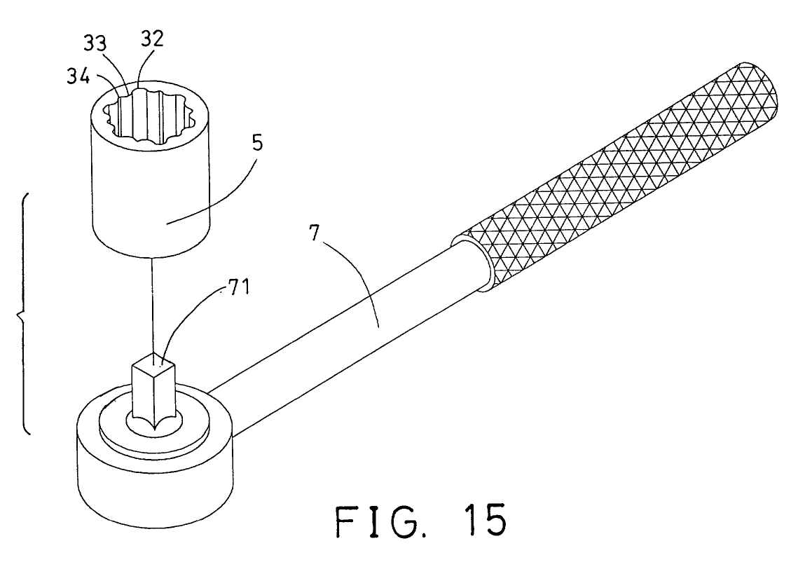

In operation, as shown in FIGS. 4, 12, when the head 2 is rotated relative to the fastener 4, the rounded bulges 23 and/or the steeper projection 25 of the driving head 2 may be caused to engage with the inner or middle portions of the flat surfaces 41 of the fasteners 4 that are spaced from the corners 42 of the fasteners 4, and will not be engaged with the corners 42 of the fasteners 4, such that the driving head 2 may also be used to rotate or to drive the fasteners 4 having rounded or worn out corners 42, as shown in FIGS. 6, 14.

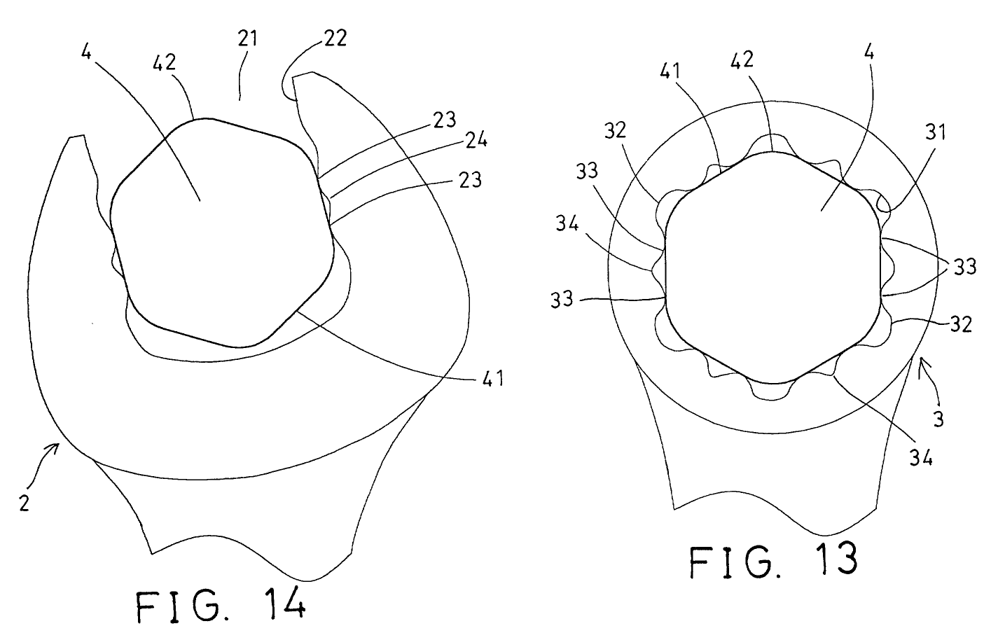

The driving head 3 includes six corner spaces 32 formed or provided in the enclosed opening 31 thereof for receiving the corners 41 of the fastener 4, and includes six sides each having two rounded bulges 33 extended inwardly into the enclosed opening 31 thereof and a curved recess 34 formed between the bulges 33 of the respective sides of the driving head 3 (FIGS. 9-11, 13).

As shown in FIGS. 1-3, and 5, the driving head 3 further includes a projection 35 extended in each of the curved recesses 34 thereof and located between the rounded bulges 33, and preferably steeper than that of the rounded bulges 33, for engaging with the middle portions of the respective edges or corners 42 of the fasteners 4.

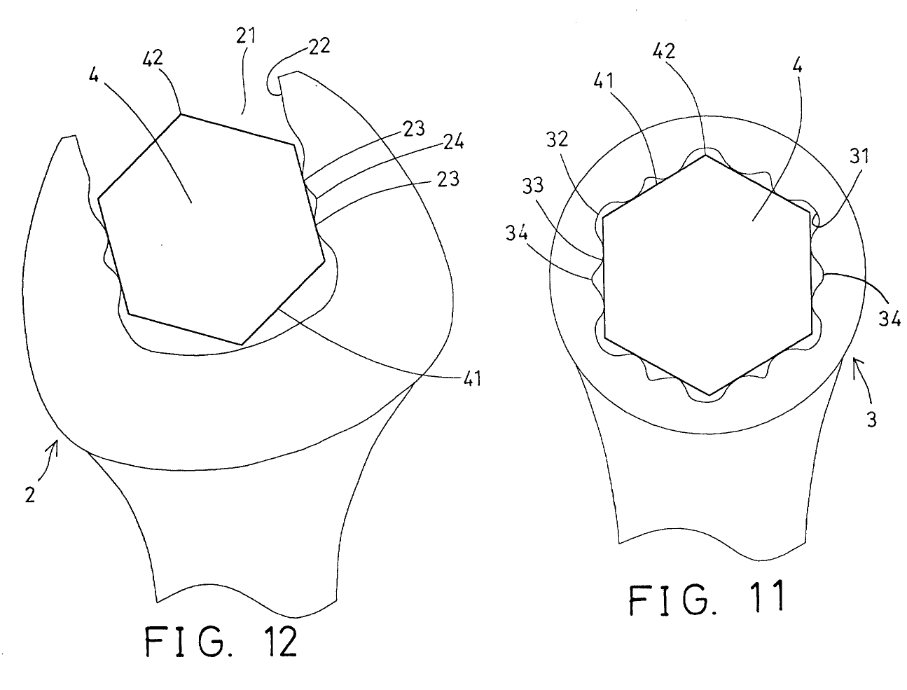

In operation, as shown in FIGS. 3, 11, when the head 3 is rotated relative to the fastener 4, the rounded bulges 33 and/or the steeper projection 35 of the driving head 3 may be caused to engage with the inner or middle portions of the flat surfaces 41 of the fasteners 4 that are spaced from the corners 42 of the fasteners 4, and will not be engaged with the corners 42 of the fasteners 4, such that the driving head 3 may also be used to rotate or to drive the fasteners 4 having rounded or worn out corners 42, as shown in FIGS. 6, 14.

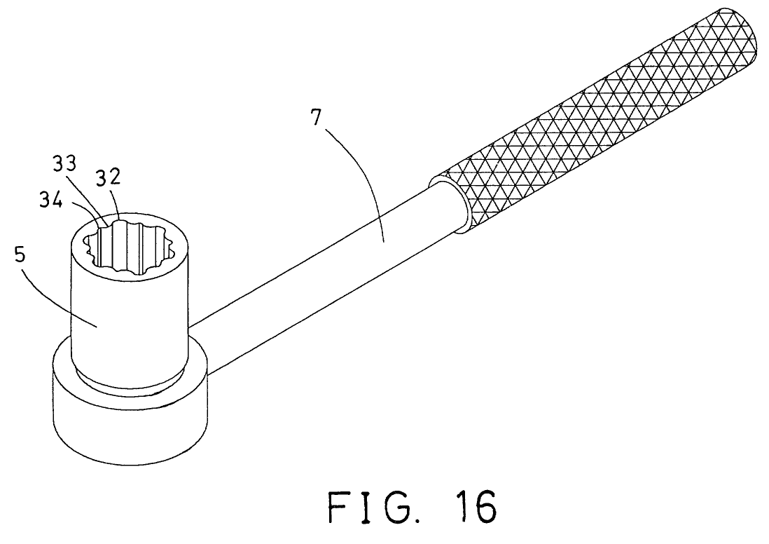

Referring next to FIGS. 15 and 16, the driving socket or the wrench socket 5 may also include a body or a head having an enclosed opening 31 as that of the head 3, and may also include six corner spaces 32 and six bulges 33 extended or provided in the enclosed opening 31 thereof. The wrench socket 5 may be rotated or driven by the driving shank 71 of the wrench tools 7, and the bulges 33 may also be used to engage with the inner or middle portions of the flat surfaces 41 of the fasteners 4 that are spaced from the corners 42 of the fasteners 4, such that the wrench socket 5 may also be used to rotate or to drive the fasteners 4 having rounded or worn out corners 42.

Accordingly, the wrench in accordance with the present invention includes a wrench opening for engaging with the flat surfaces of the fasteners instead of engaging with the corners of the fasteners, and for allowing the wrench to drive the fasteners when the corners of the fasteners are rounded or have been worn out.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A wrench cooperating with a fastener, wherein the fastener includes a plurality of surfaces joining each other at respective corners of the fastener, said wrench comprising:
a driving cylindrical member including an enclosed opening formed therein and having six corner spaces and six sides provided therein, said six sides of said driving cylindrical member each including two bulges formed and provided therein for engaging with the surfaces of the fastener, and a recess formed between said bulges respectively.

2. The wrench according to claim 1, wherein said driving cylindrical member further include three projections extended in said recesses thereof respectively and extended and disposed between said bulges.

3. The wrench according to claim 1, wherein said driving cylindrical member is a driving socket.

4. The wrench according to claim 1, wherein said wrench includes a handle having a first end and a second end, and having said driving cylindrical member disposed on said first end of said handle, and having a head provided on said second end of said handle, said head includes an open opening formed and defined between two parallel wrench flats, and two bulges extended from each of said wrench flats respectively, and a recess formed between said bulges respectively, for allowing said bulges to engage with a middle portion of the surface of the fastener that is spaced from the corners of the fastener.

5. The wrench according to claim 4, wherein said head include two projections extended in said recesses thereof respectively and extended and disposed between said bulges of each of wrench flats of said head.
